(19) United States
(12) Patent Application Publication
(10) Pub. No.: US 2020/0216032 A1
(43) Pub. Date: Jul. 9, 2020

(54) MOVING BODY

(71) Applicant: HONDA MOTOR CO., LTD., Tokyo (JP)

(72) Inventors: Shinji HIRONAKA, Wako-shi (JP); Yuki OSHITANI, Tokyo (JP)

(21) Appl. No.: 16/725,062

(22) Filed: Dec. 23, 2019

(30) Foreign Application Priority Data
Jan. 9, 2019 (JP) 2019-002097

(51) Int. Cl. B60S 1/02; B60J 1/00; B60R 11/04

(52) U.S. Cl. CPC B60S 1/026; B60R 2011/0026; B60R 11/04; B60J 1/002

(57) ABSTRACT

A moving body includes: a detection unit configured to detect a peripheral situation of the moving body; a heating unit configured to be capable of heating a component of the moving body that is positioned in a detection range of the detection unit; a position detection unit configured to detect a position of the moving body; and a control unit configured to control, based on a location where the moving body stops that is specified from a detection result of the position detection unit, operation/no operation of the heating unit during a stop of the moving body.

CROSS-REFERENCE TO RELATED APPLICATION(S)

This application claims priority to and the benefit of Japanese Patent Application No. 2019-002097 filed on Jan. 9, 2019, the entire disclosure of which is incorporated herein by reference

### BACKGROUND OF THE INVENTION

### Field of the Invention

The present invention relates to a moving body typified by a vehicle.

### Description of the Related Art

There has been proposed a perimeter security camera-equipped vehicle including a heater to remove fog on a window portion in front of the camera (for example, Japanese Patent Laid-Open No. 2017-206098). The removal of fog on the window portion can prevent the quality degradation of a captured image.

The operation of the heater involves power consumption. To suppress the power consumption, the heater may be stopped while the vehicle is parked. However, for example, when the vehicle is temporarily parked during the operation of the heater, and the heater is stopped, the vehicle may be restarted without satisfactorily removing or preventing fog. This may degrade the performance of detection by a sensor (such as a camera) at the start of traveling and degrade the detection of a peripheral situation. Further, the heater needs to be operated again to perform again the fog removal and the like, and the power consumption of the heater may increase.

### SUMMARY OF THE INVENTION

It is an object of the present invention to prevent the degradation in the performance of detection of a peripheral situation while suppressing power consumption.

According to the present invention, there is provided a moving body comprising: a detection unit configured to detect a peripheral situation of the moving body; a heating unit configured to be capable of heating a component of the moving body that is positioned in a detection range of the detection unit; a position detection unit configured to detect a position of the moving body; and a control unit configured to control, based on a location where the moving body stops that is specified from a detection result of the position detection unit, operation/no operation of the heating unit during a stop of the moving body.

Further features of the present invention will become apparent from the following description of exemplary embodiments (with reference to the attached drawings).

### BRIEF DESCRIPTION OF THE DRAWINGS

FIG. 1 is a block diagram of a vehicle and a control apparatus according to an embodiment;

FIG. 2 is a sectional view showing a structure around a detection unit;

FIG. 3 is a flowchart showing an example of processing executed by the control apparatus in FIG. 1;

FIG. 4 is a flowchart showing another example of processing executed by the control apparatus in FIG. 1; and

FIG. 5 is a flowchart showing still another example of processing executed by the control apparatus in FIG. 1.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

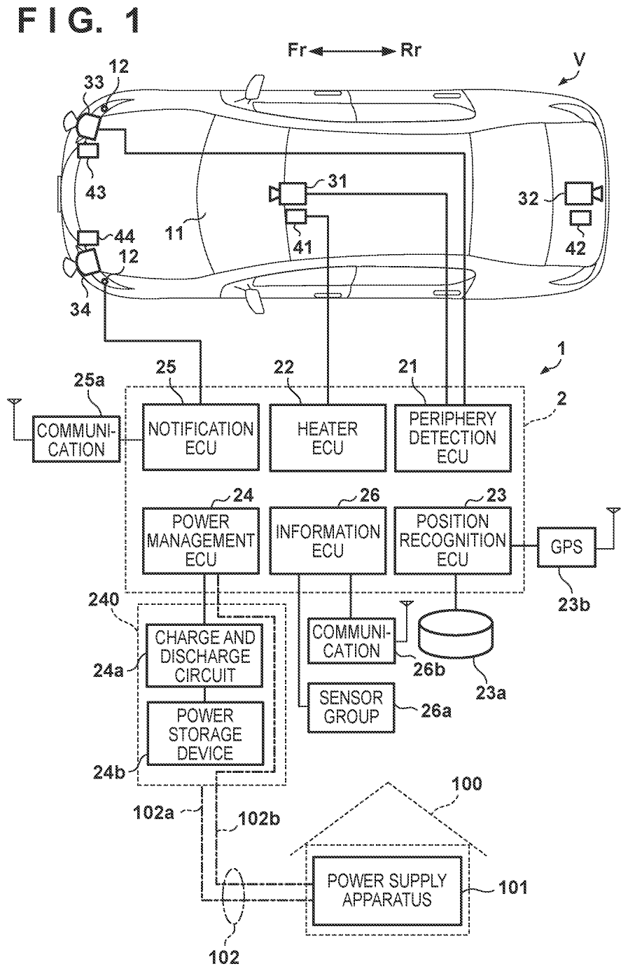

FIG. 1 is a block diagram of a vehicle V and a control apparatus 1 for the vehicle V according to an embodiment of the present invention. FIG. 1 shows the schematic arrangement of the vehicle V in a plan view. The vehicle V is a sedan-type four-wheeled vehicle and is an example of a moving body. In FIG. 1, arrows Fr and Rr indicate the front and rear sides of the vehicle V in the front-and-rear direction, respectively.

The vehicle V according to this embodiment is a plug-in hybrid vehicle. A power plant (not shown) that is a traveling driving unit configured to output a driving force to rotate the driving wheels of the vehicle V can include an internal combustion engine, a motor, and an automatic transmission. The motor can be used as a driving source configured to accelerate the vehicle V and can also be used as a power generator at the time of deceleration or the like (regenerative braking). The driving force of the internal combustion engine can be used as energy for power generation of an alternator.

### Control Apparatus

The arrangement of the control apparatus 1 that is an in-vehicle apparatus of the vehicle V will be described with reference to FIG. 1. The control apparatus 1 includes an ECU group (control unit group) 2. The ECU group 2 includes a plurality of ECUs 21 to 26 configured to be communicable with each other. Each ECU includes a processor represented by a CPU, a storage device such as a semiconductor memory, an interface to an external device, and the like. The storage device stores programs to be executed by the processor, data to be used by the processor for processing, and the like. Each ECU may include a plurality of processors, storage devices, and interfaces. The number of ECUs and the provided functions can be designed appropriately, and they can be subdivided or integrated as compared to this embodiment.

Note that FIG. 1 exemplifies ECUs necessary for the following description, and an ECU for controlling the power plant and the like are not illustrated. Also, in FIG. 1, the names of representative functions of the ECUs 21 to 26 are added. For example, the ECU 21 regarding detection of the peripheral situation of the vehicle V is described as “periphery detection ECU”.

The ECU 21 recognizes the peripheral situation (traveling environment) of the vehicle V based on the detection results of detection units 31 to 34 configured to detect the peripheral situation of the vehicle V. All the detection units 31 to 34 are monitoring devices that monitor the perimeter of the vehicle V, and are sensors capable of detecting a target outside the vehicle. In this embodiment, the detection units 31 and 32 are cameras that capture the periphery of the vehicle V and are sometimes referred to as the cameras 31 and 32. The camera 31 is arranged to capture the front of the vehicle V. In this embodiment, the camera 31 is attached to a side of a front window inside the vehicle cabin at the roof front portion of the vehicle V. The camera 32 is arranged to capture the rear of the vehicle V and is arranged on, for example, a rear bumper.

In this embodiment, the detection units 33 and 34 are lidars (Light Detection and Ranging) and are sometimes referred to as the lidars 33 and 34. The lidars 33 and 34 detect a target on the periphery of the vehicle V and measures a distance to a target. In this embodiment, the lidars 33 and 34 are provided one by one at corners of the front portion of the vehicle V.

The detection results of the detection units 31 to 34 can be used for driving assistance to a driver. The driving assistance can include collision reduction brake, lane departure suppression, or automated driving. When the possibility of collision against a front obstacle rises, the collision reduction brake assists the driver in avoiding the collision by operating a brake device. When the possibility of departure of the vehicle V from the traveling lane rises, the lane departure suppression assists the driver in avoiding the lane departure by operating an electric power steering device. The automated driving causes the vehicle V to travel without requiring a driving operation by the driver.

The ECU 22 controls heaters 41 to 44. The heaters 41 to 44 are provided in correspondence with the detection units 31 to 34. More specifically, the heater 41 is arranged next to the camera 31, and the heater 42 is arranged next to the camera 32. The heater 43 is arranged next to the lidar 33, and the heater 44 is arranged next to the lidar 34. The heaters 41 to 44 are primarily intended to prevent fog, condensation, and ice on components of the vehicle V that are positioned in the detection ranges of the corresponding detection units 31 to 34. The heaters 41 to 44 are, for example, heating wires that generate heat upon energization. The heaters 41 to 44 can also be used to prevent the freeze of the corresponding detection units 31 to 34.

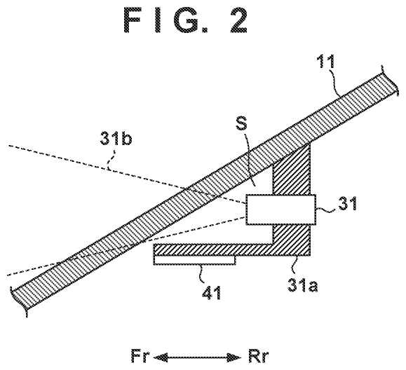

The components of the vehicle V that are positioned in the detection ranges of the detection units 31 to 34 can include exterior components such as a window member and a bumper, cover components covering the sensors of the detection units 31 to 34, and the like. The components will be exemplified with reference to FIG. 2. FIG. 2 is a vertical sectional view showing a structure around the camera 31. FIG. 2 shows an example of the attaching structure of the camera 31 to a window member 11 constituting a front window and the arrangement of the corresponding heater 41.

The camera 31 is fixed to the window member 11 via a bracket 31a. The window member 11 is, for example, a clear glass plate, and the bracket 31a is fixed to a surface of the window member 11 inside the vehicle with an adhesive or the like. A space S defined by the bracket 31a and the window member 11 communicates with the vehicle interior at the lower portion of the bracket 31a, and air can flow between the space S and the vehicle interior space. The heater 41 is supported by the bracket 31a and attached to the bottom of the bracket 31a in the example shown in FIG. 2.

The window member 11 is positioned in a detection range (image capturing range) 31b of the camera 31. When the window member 11 fogs or ices, the quality of an image captured by the camera 31 may degrade. In this case, the heater 41 is operated to warm the air in the space S by the heat, and the fog or ice on the window member 11 can be removed. The heater 41 may be provided on the window member 11 to be heated, but is provided on the bracket 31a as in this embodiment to contribute to ensuring the visibility of an occupant and the easiness of wiring.

Referring back to FIG. 1, the ECU 23 is a position recognition unit configured to recognize the current position of the vehicle V. The ECU 23 includes a GPS sensor 23b configured to detect the current position of the vehicle V, and specifies the current position of the vehicle V from the detection result of the GPS sensor 23b. A database 23a can store accurate map information. The ECU 23 can specify the position of the vehicle V more accurately based on the map information, and can specify a road on which the vehicle V travels or a location (for example, home or facility) where the vehicle V is parked.

The ECU 24 is a power management unit configured to control a power receiving apparatus 240. The power receiving apparatus 240 includes a power storage device 24b and a charge and discharge circuit 24a that charges and discharges the power storage device 24b. While the ECU 24 controls the charge and discharge circuit 24a to manage the power storage amount of the power storage device 24b, it controls supply of power stored in the power storage device 24b to an electric device of the vehicle V. The power storage device 24b is, for example, a lithium ion battery.

The power receiving apparatus 240 can receive power from an external power supply apparatus 101, and the received power can be used for charging of the power storage device 24b and the like. In this embodiment, the vehicle V and the power supply apparatus 101 can be connected via a cable 102, and power is supplied from the power supply apparatus 101 to the power receiving apparatus 240 via the cable 102. However, a wireless power transfer method is also available as the power supply method to the power receiving apparatus 240.

The cable 102 includes a power line 102a and a communication line 102b. The ECU 24 can communicate with the power supply apparatus 101 via the communication line 102b. By this communication, the ECU 24 can check whether the vehicle V is being connected to the power supply apparatus 101. For example, when the power storage amount of the power storage device 24b is small, the ECU 24 transmits a power supply request to the power supply apparatus 101, and when the power storage amount reaches a predetermined value, transmits a power supply stop instruction to the power supply apparatus 101. The power supply apparatus 101 operates in correspondence with an instruction from the ECU 24.

In this embodiment, the power supply apparatus 101 is a home power conditioner installed in a house 100 that is the home of the user of the vehicle V. The power supply apparatus 101 is an apparatus configured to perform power management in the house 100, and controls, for example, power from a solar battery (not shown) and storage/discharge of system power. Note that the apparatus that supplies power to the power receiving apparatus 240 is not limited to the home power conditioner and may be a commercial power supply apparatus at a charging station.

The ECU 25 is a notification control unit configured to control notification of information to the user of the vehicle V. In this embodiment, the ECU 25 can control driving of indicators 12. The indicators 12 are direction indicators in this embodiment and also function as notification devices to the user. As an example of the notification, the indicators 12 can be lighted in a specific pattern to prompt the user to supply power from the power supply apparatus 101 to the power receiving apparatus 240. The ECU 25 includes a communication device 25a configured to perform wireless communication. The communication device 25a can wirelessly communicate with a communication terminal such as a smartphone held by the user, and can notify the user of information. As an example of the notification, the communication device 25a can transmit a message (for example, e-mail) to the communication terminal of the user to prompt the user to supply power from the power supply apparatus 101 to the power receiving apparatus 240.

The ECU 26 is an information collection unit configured to collect various kinds of information from an in-vehicle sensor group 26a and a communication device 26b. The in-vehicle sensor group 26a includes sensors configured to detect an environment in which the vehicle V is located. These sensors are, for example, a sensor for detecting an air temperature outside the vehicle (outside air temperature), a sensor for detecting an in-vehicle temperature, and a sensor for detecting an in-vehicle humidity. The communication device 26b is a wireless communication device and acquires information by communication from an information providing server via a communication network such as the Internet. The information to be acquired is, for example, weather information. The weather information includes air temperature, humidity, weather, or weather forecast.

### Control Example 1

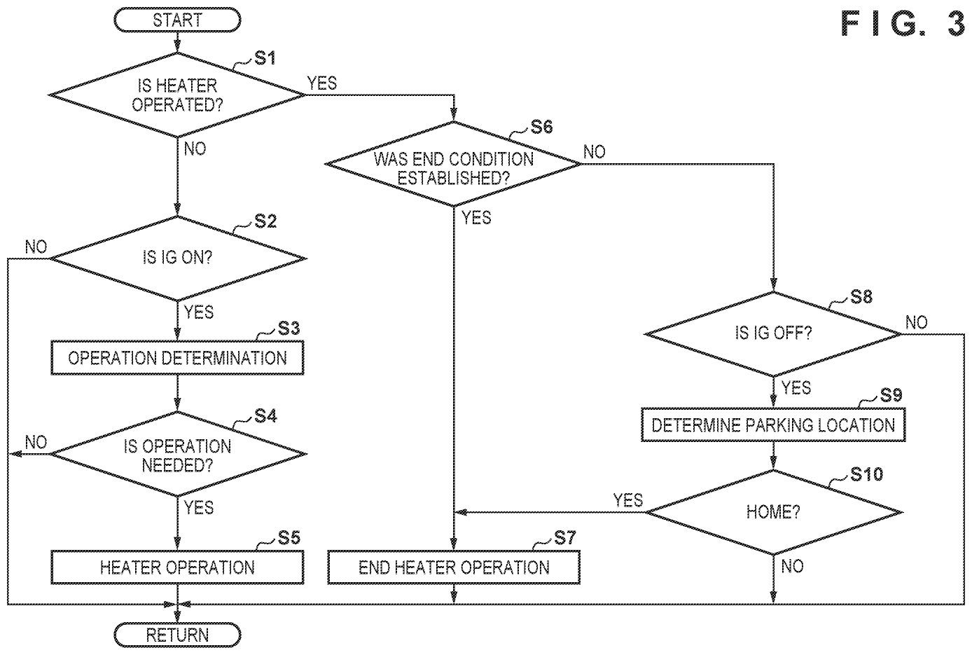

A control example of the control apparatus 1 will be described. FIG. 3 is a flowchart showing an example of driving control processing of the heater 41 executed by the ECU 22. Note that similar control is also applicable to the heaters 42 to 44.

The operation of the heater 41 involves power consumption. To suppress the power consumption, the heater 41 may be stopped during parking of the vehicle V during which the necessity to detect a peripheral situation is low. However, for example, when the vehicle V is temporarily parked during the operation of the heater 41 and the heater 41 is stopped, the vehicle V may restart before fog is satisfactorily removed or prevented. This may degrade the performance (for example, image capturing quality) in detection by the camera 31 at the start of traveling and degrade the performance in detection of a peripheral situation. After the vehicle V starts moving, the heater 41 needs to be operated again to perform again the fog removal and the like, and the power consumption of the heater 41 may increase.

In this embodiment, operation/no operation of the heater 41 is controlled in accordance with the location (parking location) where the vehicle V stops. In particular, whether to end the operation of the heater 41 that has started during traveling of the vehicle V is controlled in accordance with a parking location at the time of parking.

The processing example in FIG. 3 is executed repetitively in a predetermined cycle. In step S1, it is determined which of the operation state and the operation stop state the heater 41 is in. If the heater 41 is in the operation stop state, the process advances to step S2; if it is in the operation state, to step S6.

In step S2, it is determined whether the ignition (IG) is ON. If the ignition is ON, the process advances to step S3; if the ignition is not ON, the process ends. The case in which the ignition is ON is a state in which the internal combustion engine is being driven or is to be driven soon, and power can be generated using the driving force. Even if the heater 41 is operated, the generated power can be used, and a decrease in the power storage amount of the power storage device 24b can be suppressed.

In step S3, it is determined whether the heater 41 needs to be operated. The case in which the heater 41 needs to be operated is, for example, a case in which already present fog or ice is removed or the occurrence of fog is prevented, and in other words, a case in which moisture attaches to the window member 11 or is predicted to attach. Whether moisture attaches to the window member 11 can be determined from, for example, an image captured by driving the camera 31. If the presence of fog or ice is confirmed by image analysis of the captured image, it can be determined that the heater 41 needs to be operated to remove the fog or ice.

The attachment of moisture to the window member 11 can be predicted based on an environment in which the vehicle V is located. More specifically, this can be predicted based on, for example, information of an outside air temperature, a change of the outside air temperature per unit time, an in-vehicle humidity, a season, or weather that is collected by the ECU 26. When the outside air temperature is low or suddenly changes to be low (for example, a change of about 10° C.), the window member 11 easily fogs up. At a high in-vehicle humidity or in a cold season (December to February in Japan), the window member 11 easily fogs up. To the contrary, the fog is hardly generated in a warm season (July to September in Japan). When it rains, the fog occurs more easily. Based on such environment information, it can be predicted whether moisture will attach to the window member 11, for example, fog will be generated.

In step S4, if it is determined from the determination processing in step S3 that the heater 41 needs to be operated, the process advances to step S5; if it is determined that the heater 41 need not be operated, the process ends. In step S5, the heater 41 is controlled to change to the operation state. More specifically, the heater 41 is energized. Accordingly, fog on the window member 11 can be removed or prevented, and the performance in detection by the camera 31 can be easily ensured.

In step S6, it is determined whether the operation end condition of the heater 41 has been established. The operation end condition is that, for example, the driving time of the heater 41 has reached a predetermined value or an operation requiring situation in the operation determination of step S3 is canceled. If the operation end condition has been established, the process advances to step S7 to end the operation of the heater 41. More specifically, the energization to the heater 41 is stopped. If the operation end condition has not been established, the process advances to step S8.

In step S8, whether the vehicle V is parked is determined from whether the ignition (IG) is OFF. If the ignition is OFF, it is considered that the vehicle V is parked, and the process advances to step S9. If the ignition is not OFF, the process ends. In step S9, the parking location of the vehicle V is determined. The parking location is determined based on the current position of the vehicle V that is acquired from the ECU 23. In step S10, whether the parking location is home is determined from the result of the determination in step S9. If the parking location is home, the vehicle V is highly likely to be parked for a long time, so the process advances to step S7 to end the operation of the heater 41. If the parking location is not home, the vehicle V is likely to restart in a short time, so the process ends to continue the operation of the heater 41.

In this control example, when the vehicle V is parked at home where long-time parking is predicted, the operation of the heater 41 is stopped so that unnecessary consumption of power by the heater 41 can be suppressed. To the contrary, when the vehicle V is parked at a location, other than home, where short-time parking is predicted, the operation of the heater 41 is continued so that fog can be removed or prevented, and the degradation of the performance in detection of a peripheral situation by the camera 31 can be prevented in preparation for restart.

### Control Example 2

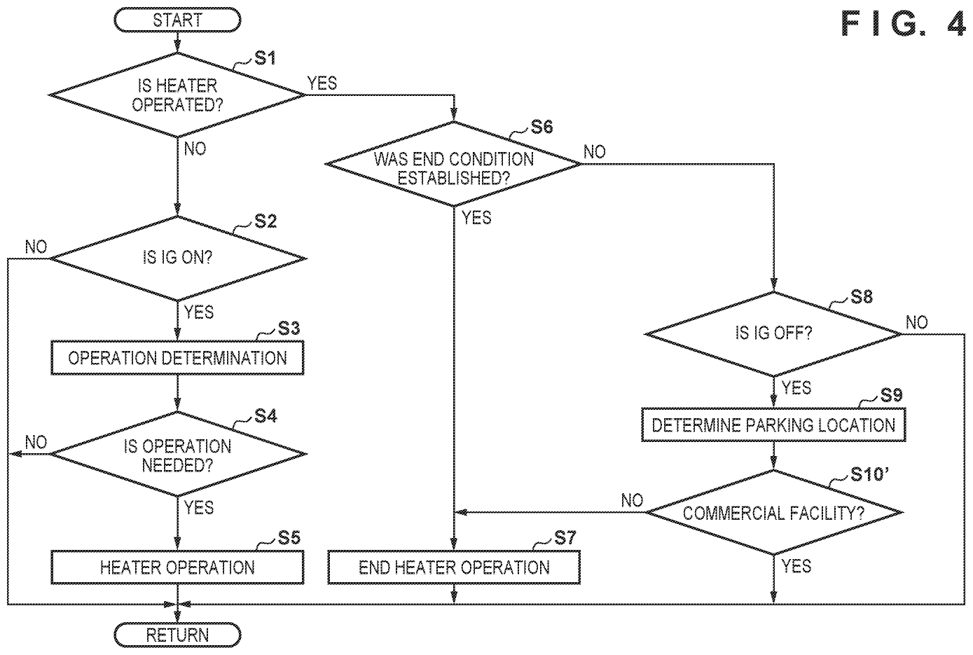

Another control example of the control apparatus 1 will be described. FIG. 4 is a flowchart showing an example of driving control processing of the heater 41 executed by the ECU 22. This control example takes the place of the control example in FIG. 3. Note that similar control is also applicable to the heaters 42 to 44.

In control example 2, step S10 in control example 1 is replaced with step S10′. The remaining processes in control example 2 are the same as those in control example 1 and a repetitive description thereof will be omitted.

In step S10′, whether the parking location is a commercial facility is determined from the result of the determination in step S9. An example of the commercial facility can be a relatively small shop such as a convenience store or a restaurant. If the parking location is a commercial facility, the vehicle V is likely to restart in a short time, so the process ends to continue the operation of the heater 41. If the parking location is not a commercial facility, the vehicle V is highly likely to be parked for a long time, so the process advances to step S7 to end the operation of the heater 41.

In this control example, when the vehicle V is parked at a commercial facility where short-time parking is predicted, the operation of the heater 41 is continued so that fog can be removed or prevented, and the degradation in the performance in detection of a peripheral situation by the camera 31 can be prevented in preparation for restart. In contrast, when the vehicle V is parked at a location, other than a commercial facility, where the vehicle V is likely to be parked for a long time, the operation of the heater 41 is stopped so that unnecessary consumption of power by the heater 41 can be suppressed.

Note that a commercial facility subjected to the determination in step S10′ may be a commercial facility of a predetermined category or shop. The predetermined category or shop can include a convenience store and a restaurant as described above.

### Control Example 3

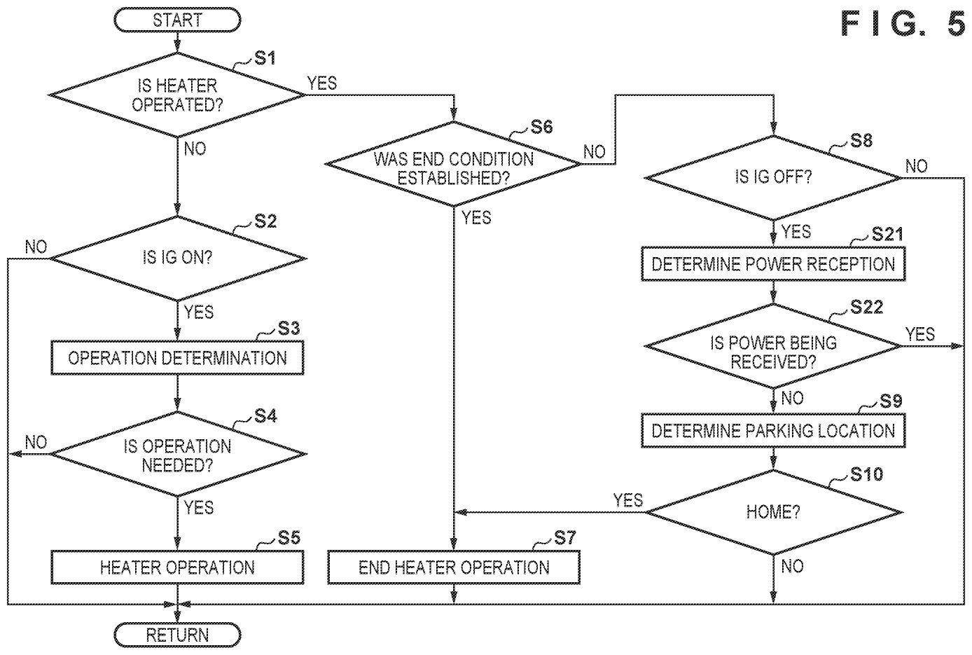

Still another control example of the control apparatus 1 will be described. FIG. 5 is a flowchart showing an example of driving control processing of the heater 41 executed by the ECU 22. This control example takes the place of the control example in FIG. 3. Note that similar control is also applicable to the heaters 42 to 44.

In control example 3, processes in steps S21 and S22 are added to control example 1. The remaining processes in control example 3 are the same as those in control example 1 and a repetitive description thereof will be omitted.

If the ignition is OFF in step S8, it is determined that the vehicle V is parked, and the process advances to step S21. If the ignition is not OFF, the process ends. In step S21, it is determined whether the power receiving apparatus 240 receives power from an external power supply apparatus such as the power supply apparatus 101. Whether the power receiving apparatus 240 receives power can be determined by checking the ECU 24. Power reception requires, for example, work of connecting the cable 102 to the vehicle V. Thus, the determination processing in step S21 may continue for a predetermined time (for example, several min) after the ignition is switched to OFF.

If the power receiving apparatus 240 receives power in step S22 as a result of the determination in step S21, the process ends to continue the operation of the heater 41. Since the driving power of the heater 41 can be covered by power received from the power supply apparatus 101, a decrease in the power storage amount of the power storage device 24b can be suppressed. If the power receiving apparatus 240 does not receive power, the process advances to step S9 to perform similar processing as that in control example 1.

In this control example, when the power receiving apparatus 240 receives power from an external power supply apparatus such as the power supply apparatus 101, the heater 41 is controlled to change to the operation state regardless of the parking location of the vehicle V, so fog can be removed or prevented.

Note that the processing in step S10 of control example 3 can also be replaced with the processing in step S10′ of control example 2. After the operation of the heater 41 ends in accordance with a parking location as in a case in which the vehicle V is parked at home, the heater 41 may be controlled to change to the operation state in response to the start of receiving power by the power receiving apparatus 240 from an external power supply apparatus such as the power supply apparatus 101.

### Other Embodiments

In the above-described embodiment, a four-wheeled vehicle has been described as an example of the moving body. However, the moving body includes vehicles such as a four-wheeled vehicle and a two-wheeled vehicle, and apparatuses with a movement propulsion mechanism such as a ship and a flying machine. The flying machine may be an aircraft such as a rotary aircraft, a fixed-wing aircraft, and an airship, flying personal transporter, a spacecraft, and a space shuttle. The four-wheeled vehicle is not limited to a plug-in hybrid vehicle as in the above-described embodiment, but is also an electric car having no internal combustion engine.

In the above-described embodiment, the cameras 31 and 32 and the lidars 33 and 34 have been exemplified as detection units configured to detect the peripheral situation of the vehicle V. However, the detection units are not limited to them and, for example, a milliwave radar and an ultrasonic sensor can also be adopted. The number and layout of detection units are not limited to those in the example of FIG. 1 and can be designed appropriately. For example, side cameras may be provided to capture images on the sides of the vehicle V.

The heaters 41 to 44 are provided individually for the respective detection units 31 to 34 in the above-described embodiment, but there may be a detection unit having no heater. Alternatively, adjacent detection units may share a common heater. The processes in FIGS. 3 to 5 may be performed for all or some of the heaters.

In the above-described embodiment, when the ignition is OFF, the operation of the heater is not started in the processes of steps S2 to S5. However, even when the ignition is OFF, the operation of the heater may be started if a predetermined condition is established. For example, when the vehicle V is likely to restart in a short time as in a case in which the vehicle V is parked at a commercial facility, the processes in steps S3 to S5 may be executed. For example, the processes in steps S3 to S5 may be executed a predetermined time (for example, 15 min) before the estimated time of use of the vehicle V. The estimated time of use of the vehicle V may be registered in advance in the control apparatus 1 by the user or may be predicted by the control apparatus 1 from the history of past use of the vehicle V. Also, for example, when the power storage amount of the power storage device 24b is equal to or larger than a predetermined value, the processes in steps S3 to S5 may be executed.

In the above-described embodiment, whether the vehicle V is parked is determined from whether the ignition is OFF (step S8). However, whether the vehicle V is parked may be determined based on another factor such as whether the speed is 0.

### Summary of Embodiment

The above-described embodiment discloses at least the following embodiments.

1. A moving body (for example, V) according to the above-described embodiment comprises:

a detection unit (for example, 31) configured to detect a peripheral situation of the moving body;

a heating unit (for example, 42) configured to be capable of heating a component (for example, 11) of the moving body that is positioned in a detection range of the detection unit;

a position detection unit (for example, 23b) configured to detect a position of the moving body; and a control unit (for example, 1, 22) configured to control, based on a location where the moving body stops that is specified from a detection result of the position detection unit, operation/no operation of the heating unit during a stop of the moving body.

According to this embodiment, the degradation in the performance in detection of a peripheral situation can be prevented while suppressing power consumption.

2. In the above-described embodiment,

when the location where the moving body stops is a commercial facility, the control unit controls the heating unit so as to be in an operation state (for example, S10′).

According to this embodiment, when the moving body is likely to move again in a short time, the heating unit is operated, and the degradation in the performance in detection of a peripheral situation by the detection unit can be prevented.

3. In the above-described embodiment, when the control unit controls the heating unit so as to be in the operation state during the stop of the moving body, the control unit ends the operation of the heating unit in response to establishment of a predetermined end condition (for example, S6).

According to this embodiment, unnecessary operation of the heating unit can be prevented, and power consumption can be suppressed.

4. In the above-described embodiment, when the moving body stops moving while the heating unit is in the operation state (for example, S1, S6, S8), the control unit controls, based on the location where the moving body stops, operation/no operation of the heating unit during the stop of the moving body.

According to this embodiment, when the moving body is likely to move again in a short time, the heating unit can be kept operated without operating again the heating unit. When the moving body is likely to stop for a long time, the operation of the heating unit ends and power consumption can be suppressed.

5. In the above-described embodiment,

the moving body further comprises a power receiving unit (for example, 240) configured to receive power from an external power supply apparatus of the moving body, and

when the power receiving unit receives power from the power supply apparatus during the stop of the moving body, the control unit controls the heating unit so as to be in the operation state regardless of the location where the moving body stops (for example, S21, S22).

According to this embodiment, power can be used from the power supply apparatus, so priority can be given to preventing the degradation in the performance in detection of a peripheral situation by the detection unit, and the heating unit can be controlled to change to the operation state.

6. In the above-described embodiment,
the moving body is a vehicle,
the detection unit is a camera,
the component is a window member positioned in an image capturing range of the camera, and
the heating unit is a heater configured to remove fog on the window member.

According to this embodiment, the image capturing performance of the camera that is easily influenced by fog can be ensured easily.

The invention is not limited to the foregoing embodiments, and various variations/changes are possible within the spirit of the invention.

What is claimed is:

1. A moving body comprising:
a detection unit configured to detect a peripheral situation of the moving body;
a heating unit configured to be capable of heating a component of the moving body that is positioned in a detection range of the detection unit;
a position detection unit configured to detect a position of the moving body; and
a control unit configured to control, based on a location where the moving body stops that is specified from a detection result of the position detection unit, operation/no operation of the heating unit during a stop of the moving body.

2. The body according to claim 1, wherein when the location where the moving body stops is a commercial facility, the control unit controls the heating unit so as to be in an operation state.

3. The body according to claim 1, wherein when the control unit controls the heating unit so as to be in the operation state during the stop of the moving body, the control unit ends the operation of the heating unit in response to establishment of a predetermined end condition.

4. The body according to claim 1, wherein when the moving body stops moving while the heating unit is in the operation state, the control unit controls, based on the location where the moving body stops, operation/no operation of the heating unit during the stop of the moving body.

5. The body according to claim 1, further comprising a power receiving unit configured to receive power from an external power supply apparatus of the moving body,
wherein when the power receiving unit receives power from the power supply apparatus during the stop of the moving body, the control unit controls the heating unit so as to be in the operation state regardless of the location where the moving body stops.

6. The body according to claim 1, wherein
the moving body is a vehicle,
the detection unit is a camera,
the component is a window member positioned in an image capturing range of the camera, and
the heating unit is a heater configured to remove fog on the window member.
